(19) United States
(12) Patent Application Publication
(10) Pub. No.: US 2016/0182860 A1
(43) Pub. Date: Jun. 23, 2016

(54) METHODS FOR PERFORMING IMAGE CAPTURE AND REAL-TIME IMAGE DISPLAY ON PHYSICALLY SEPARATED OR SEPARABLE DEVICES AND APPARATUS THEREFOR

(71) Applicant: Xiaoyi Technology Co., Ltd., Shanghai (CN)

(72) Inventor: Guomin YU, Shanghai (CN)

(73) Assignee: Xiaoyi Technology Co., Ltd.

(21) Appl. No.: 14/941,899

(22) Filed: Nov. 16, 2015

(30) Foreign Application Priority Data
Dec. 18, 2014 (CN) 201410804909.2

(51) Int. Cl. H04N 7/18; H04N 5/232; G06K 9/00; H04N 5/77

(52) U.S. Cl. CPC H04N 7/18; H04N 5/772; H04N 5/23293; G06K 9/00664

(57) ABSTRACT

A method of capturing an image by an image capturing device for real-time display of the image by an image displaying device that is physically separated or separable from the image capturing device is provided. The method includes capturing an image of a scene by an image capturing device, and transmitting the image to an image displaying device for real-time display. The image displaying device is physically separated or separable from the image capturing device when displaying the image. An apparatus for capturing an image for real-time display by an image displaying device that is separated or separable from the image capturing device is also provided.

### PRIORITY INFORMATION

The present application hereby claims priority under 35 U.S.C. §119 to Chinese patent application number CN 201410804909.2 filed Dec. 18, 2014, the entire contents of which are incorporated herein by reference.

### TECHNOLOGY FIELD

The present disclosure relates to image capture and display devices and, in particular, to methods and apparatus for performing image capture and real-time image display on physically separated or separable devices.

### BACKGROUND

As techniques of image capturing have progressed, an image capturing device can not only capture still or slow moving objects, but can also can capture fast moving objects, or capture images while the image capture device itself is moving. Image capturing devices are useful in a variety of fields such as photography, video recording, image collection, security surveillance, etc.

Conventionally, an image capturing device is equipped with an integrated display panel. Images captured by a conventional image capturing device may also be transferred out of the image capturing device for better viewing. For example, captured images may be transferred out of an image capturing device using a memory card and loaded into a computer for viewing. Even for an image capturing device having a display panel, it may not be convenient for a user to view captured images at the same time the user is capturing images using the device. For example, a user may not be able to properly view captured images on the image capturing device in the case that the user needs to hold the image capturing device away from their face to capture desired images. In such cases, a user may orient the image capturing device such that it is difficult or near impossible to view the integrated display.

### SUMMARY

Consistent with embodiments of the present disclosure, there is provided a method and apparatus for performing image capturing and real-time image display on physically separately or separable devices. An image capturing device according to the disclosure can include a camera, a mobile phone having a camera, and any device capable of implementing an image capturing function. An image displaying device according to the disclosure can include smart glasses, a helmet, a hat, and any device capable of implementing an image displaying function.

According to a first aspect of the disclosure, there is provided a method of capturing an image for real-time display. The method can include: capturing an image of a scene by an image capturing device; and transmitting the image to an image displaying device for real-time display. The image displaying device is physically separated or separable from the image capturing device when displaying the image.

According to a second aspect of the disclosure, there is provided a method of displaying an image in real time. The method can include: receiving by an image displaying device an image transmitted in real time from an image capturing device at the same time the image capturing device is capturing one or more images; and playing back in real time the image. The image displaying device is physically separated or separable from the image capturing device when playing back the image.

According to a third aspect of the disclosure, there is provided an apparatus for capturing an image for real-time display. The apparatus can include: an acquisition module for capturing an image of a scene; and a first transmission module for transmitting the image to an image displaying device for real-time display. The image displaying device is physically separated or separable from the apparatus when displaying the image.

According to a fourth aspect of the disclosure, there is provided an apparatus for displaying an image in real time. The apparatus can include: a first image receiving module for receiving an image transmitted in real time from an image capturing device at the same time the image capturing device is capturing one or more images; and a playback module for playing back in real time the image. The apparatus is physically separated or separable from the image capturing device when playing back the image

According to a fifth aspect of the disclosure, there is provided an apparatus for capturing an image for real-time display. The apparatus can include: a processor; and a memory for storing instructions executable by the processor, wherein the processor is configured to: capturing an image of a scene; and transmit the image to an image displaying device for real-time display. The image displaying device is physically separated or separable from the apparatus when displaying the image.

According to a sixth aspect of the disclosure, there is provided an apparatus for displaying an image in real time. The apparatus can include: a processor; and a memory for storing instructions executable by the processor, wherein the processor is configured to: receive an image transmitted in real time from an image capturing device at the same time the image capturing device is capturing one or more images; and play back in real time the image. The apparatus is physically separated or separable from the image capturing device when playing back the image.

According to a seven aspect of the disclosure, there is provided a method of capturing an image. The method can include: generating a view of a scene by an image capturing device; generating data reflecting the view by the image capturing device; transmitting the data reflecting the view from the image capturing device to an image displaying device for real-time display of the view, wherein the image displaying device is physically separated or separable from the image capturing device when displaying the view; and capturing an image by the image capturing device based on feedback based on the displayed view.

As will be explained below in the description, a user may monitor or view in real time one or more images captured by an image capturing device on an image displaying device without limitations imposed by the prior art image capturing devices. For example, by employing an embodiment of the disclosure, images captured by an image capturing device can be properly or clearly viewed by a user in real time even if the image capturing device is undergoing a motion.

Features and advantages consistent with the disclosure will be set forth in part in the description which follows, and in part will be obvious from the description, or may be learned by practice of the disclosure. Such features and advantages will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of this specification, illustrate embodiments of the invention and together with the description, serve to explain the principles of the invention. It is understood, however, that the invention is not limited to the precise arrangements and instrumentalities shown in the drawings, wherein:

FIG. 1 is a flow chart of a method of capturing and transmitting an image of a scene for real-time display according to certain embodiments of the disclosure;

FIG. 2 is another flow chart of a method of capturing and transmitting an image of a scene for real-time display according to certain embodiments of the disclosure;

FIG. 3 is another flow chart of a method of capturing and transmitting an image of a scene for real-time display according to certain embodiments of the disclosure;

FIG. 4 is a flow chart of a method of capturing and transmitting an image of a scene for real-time display according to a first embodiment of the disclosure;

FIG. 5 is a flow chart showing optionally additional steps of a method of capturing and transmitting an image of a scene for real-time display according to a second embodiment of the disclosure;

FIG. 6. is a flow chart of a method of displaying an image in real time according to certain embodiments of the disclosure;

FIG. 7 is another flow chart of a method of displaying an image in real time according to certain embodiments of the disclosure;

FIG. 8 is another flow chart of a method of displaying an image in real time according to certain embodiments of the disclosure;

FIG. 9 is a flow chart of a method of displaying an image in real time according to a third embodiment of the disclosure;

FIG. 10 is a flow chart of a method of displaying an image in real time according to a fourth embodiment of the disclosure;

FIG. 11 is an exemplary representation of an action camera and smart glasses being physically separated from each other according to certain embodiments of the disclosure;

FIG. 12 is a block diagram of an apparatus for capturing an image for real-time display according to certain embodiments of the disclosure;

FIG. 13 is another block diagram of an apparatus for capturing an image for real-time display according to certain embodiments of the disclosure;

FIG. 14 is another block diagram of an apparatus for capturing an image for real-time display according to certain embodiments of the disclosure;

FIG. 15 is a block diagram of an apparatus for displaying an image in real time according to certain embodiments of the disclosure;

FIG. 16 is another block diagram of an apparatus for displaying an image in real time according to certain embodiments of the disclosure;

FIG. 17 is another block diagram of an apparatus for displaying an image in real time according to certain embodiments of the disclosure;

FIG. 18 is another block diagram of an apparatus for displaying an image in real time according to certain embodiments of the disclosure; and

FIG. 19 is block diagram of an apparatus for capturing an image for real-time display or for displaying an image in real time according to certain embodiments of the disclosure.

### DESCRIPTION OF THE EMBODIMENTS

Embodiments consistent with the disclosure include a method of capturing and displaying images. For example, the method can include capturing an image by a first device that is physically separated or separable from a second device for displaying the captured image. Alternatively, or additionally, the method can include displaying a captured image by a second device that is physically separated or separable from a first device for capturing images. Embodiments consistent with the disclosure also include an apparatus for capturing and displaying images. For example, the apparatus can include a first device for capturing an image for real-time display by a second device. Alternatively, or additionally, the apparatus can include a second device for displaying a captured image captured by a first device.

Hereinafter, embodiments consistent with the disclosure will be described with reference to drawings. Wherever possible, the same reference numbers will be used throughout the drawings to refer to the same or like parts.

According to some embodiments of the disclosure, a method of capturing an image by a first device for real-time display of the captured image by a second device that is physically separated or separable from the first device is provided. In the method, an image is captured by an image capturing device. The image may exist or be processed in a form of data stream in the image capturing device. A data stream representing the image captured by the image capturing device can be transmitted to an image displaying device for real-time display. The data stream representing the captured image received by the image displaying device can be played back in real time.

The image capturing device can be physically separated or separable from the image displaying device such that a user can monitor or view one or more captured images being displayed in real time by the image displaying device while the user is able to move around the image capturing device to capture one or more images. Thus, a user may monitor or view in real time one or more images captured by the image capturing device on the image displaying device without limitations imposed by the image capturing device. For example, by employing an embodiment of the disclosure, images captured by the image capturing device can be property or clearly viewed by a user even if the image capturing device is capturing images while undergoing a motion.

The image capturing device can be configured to capture one or more images in a variety of ways. For example, an image capturing device can be configured to capture images by a user, by programming, by hardware setting, or by a combination thereof. In some embodiments, when an image capturing device is configured to capture images by software or hardware programming or by hardware setting, image capturing can be performed at one or more predetermined conditions. For example, a set of predetermined conditions can trigger an image capturing device to capture images. Alternatively, or additionally, an image capturing device can capture images in response to a user's operation. In some embodiments, capturing images may include that an image capturing device is in a mode or setting capable of capturing one or more images. In some embodiments, capturing images may include capturing one or more images. As used herein, an “image” can refer to, in part or in whole, a static or dynamic visual representation including, but not limited to, a photo, a picture, a graphic, a video, a hologram, a virtual reality image, an augmented reality image, other visual representations, or combination thereof. As used herein, “displaying an image,” “displaying an image document,” “displaying a data stream of an image,” or related phrases or terms can refer to rendering an image for viewing and can include playing back a still or dynamic image.

As used herein, the term “real-time” refers to the display of an image prior to, at the same time of, or within so short a time after its capture (on the order of milliseconds or tens of milliseconds), so that the displayed image is useful as feedback to reorient the camera by hand to capture a desired image of a typical moving object, such as a vehicle or sports scene.

For example, the image capturing device may first generate a view of a scene without capturing an image, generate data reflecting the view, and send the data to the image display device for real-time display of the view. The user may, based on the displayed view of the scene, adjust the position and/or orientation of the image capturing device so that a desired image may be captured, e.g., stored as an image file.

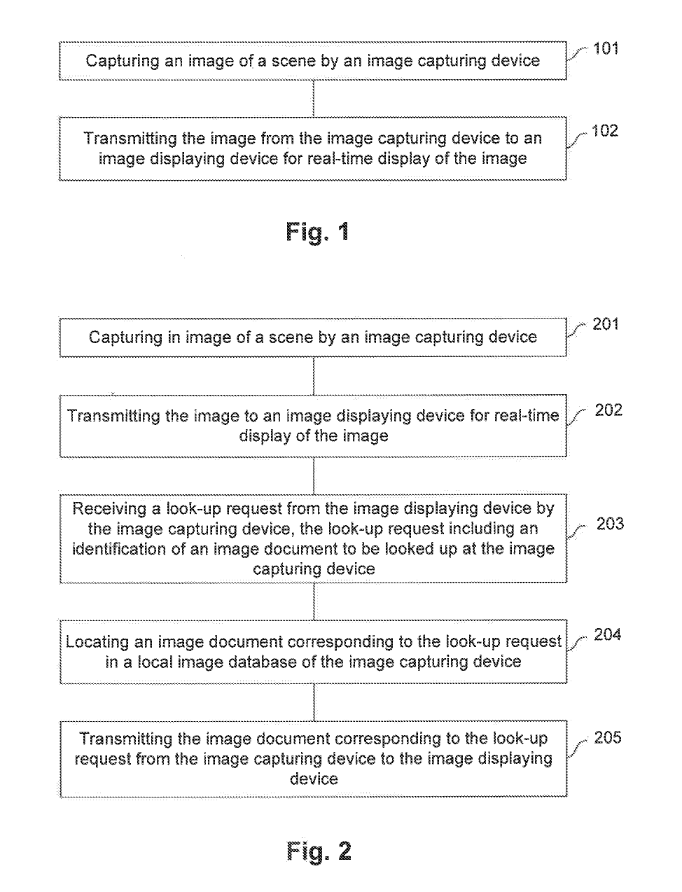

FIG. 1 illustrates a method of capturing an image by a first device for real-time display of the captured image by a second device that is physically separated or separable from the first device according to some embodiments of the disclosure. The method can be applied to an image capturing device. As shown in FIG. 1, an image is captured by an image capturing device in step 101. Capturing an image of a scene can include capturing one or more images of a scene. For example, an image can be acquired after capturing one or more images of a scene. In step 102, the image is transmitted from the image capturing device to an image displaying device for real-time display of the captured image. The image capturing device and the image displaying device can be physically separated or separable from each other. For example, the image displaying device can be physically separated or separable from the image capturing device while the image displaying device is displaying an image in real time as the image capturing device is capturing images. The image can be constituted by a data stream. A data stream of a captured image can be transmitted from the image capturing device to the image displaying device. A data stream of an image transmitted to an image displaying device can include a data stream of an image acquired after the image is captured by the image capturing device. A data stream of an image transmitted to an image displaying device can be data acquired after an image capturing device captures one or more images of a scene. The image displaying device can be configured to play back in real time the transmitted data stream by displaying an image, such as one that is corresponding to the transmitted data stream.

FIG. 2 illustrates that, according to some embodiments of the disclosure, a method of capturing an image by an image capturing device for real-time display of the captured image by an image displaying device that is physically separated or separable from the image capturing device can include steps 201 and 202 that are similar to steps 101 and 102 in FIG. 1 and additionally include the steps of: receiving a look-up request transmitted from the image displaying device by the image capturing device, the look-up request including an identification of an image document to be looked up at the image capturing device (step 203); locating an image document corresponding to the look-up request in a local image database of the image capturing device (step 204); and transmitting the image document corresponding to the look-up request from the image capturing device to the image displaying device (step 205).

As will be described in more details below, a look-up request can be transmitted from an image displaying device. Based on the look-up request, an image document can be located and transmitted from the image capturing device to the image displaying device. The image document corresponding to the look-up request can be played back in real time on the image displaying device. Because the image capturing device is physically separated or separable from an image displaying device, a user can use the image capturing device to capture images while at the same time being able to view one or more images previously captured by the image capturing device on the image displaying device without limitations imposed by the image capturing device. The image displaying device can display an identified image or an image the user has intended to look up. For example, it may be convenient for the user to look up images that have been captured on the image capturing device without having to stop capturing images in order to look up and view the images.

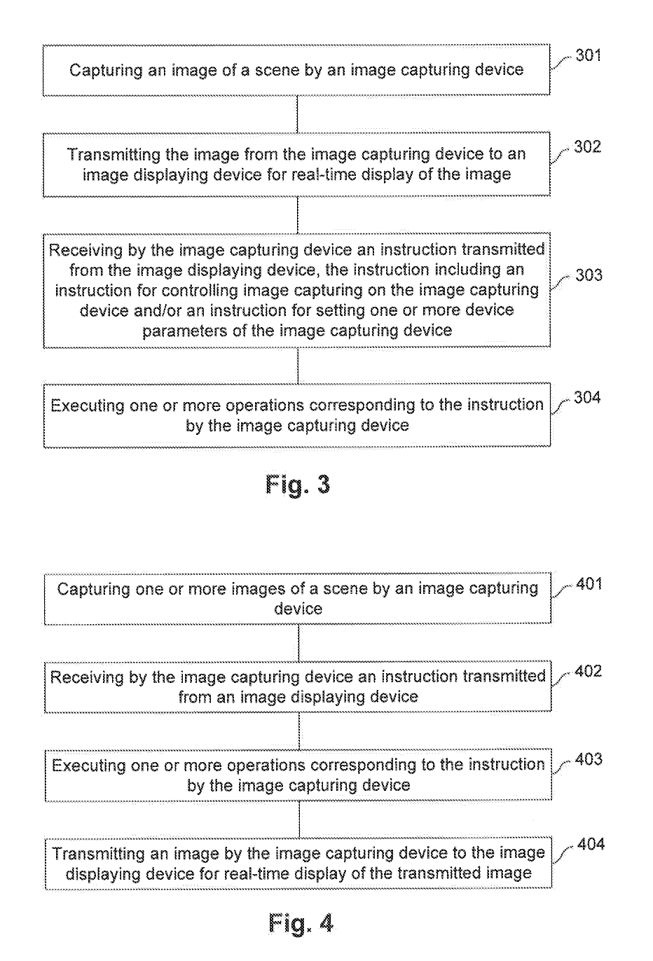

FIG. 3 illustrates that, according to some embodiments of the disclosure, a method of capturing an image by an image capturing device for real-time display of the captured image by an image displaying device that is physically separated or separable from the image capturing device can include steps 301 and 302 that are similar to steps 101 and 102 in FIG. 1 and additionally include the steps of: receiving by the image capturing device an instruction transmitted from the image displaying device, the instruction including an instruction for controlling image capturing on the image capturing device and/or an instruction for setting one or more device parameters of the image capturing device (step 303); and executing one or more operations corresponding to the instruction by the image capturing device (step 304).

As will be described in more details below, an instruction transmitted from the image displaying device can be received by the image capturing device, which may then, based on the instruction, executes one or more operations corresponding to the instruction. For example, a user can use an image capturing device to capture images while the image capturing device is able to receive an instruction transmitted from an image displaying device. While the user is still capturing images by using the image capturing device, the image capturing device can, at the same time, execute one or more operations corresponding to the instruction. For example, even when the image capturing device is moving while capturing images, the image capturing device can be configured to receive an instruction transmitted from the image displaying device and to execute one or more operations corresponding to the instruction to change its capturing operation or device setting. Thus, the user may continue to capture images using the image capturing device without having to stop capturing images in order to change capturing operations or device settings.

The present disclosure is further exemplified by a number of specific embodiments described below. These embodiments illustrate a few of many ways that the disclosure can be implemented. As is understood by a person of skilled in the art, however, the specific embodiments are only exemplary for illustrating the present disclosure and should not be considered as limiting.

### First Embodiment

FIG. 4 illustrates a method of capturing an image by an image capturing device for real-time display of the captured image by an image displaying device that is physically separated or separable from the image capturing device according to a first embodiment of the disclosure. The method described in the first embodiment can be applied, for example, to an action camera. The method will be described below in terms of a number of steps as shown in FIG. 4.

In step 401, one or more images of a scene are captured by an image capturing device. For example, a captured image can be encoded as a data stream by the image capturing device. A data stream of an image can be processed and encoded during or after capturing one or more images of a scene by the image capturing device.

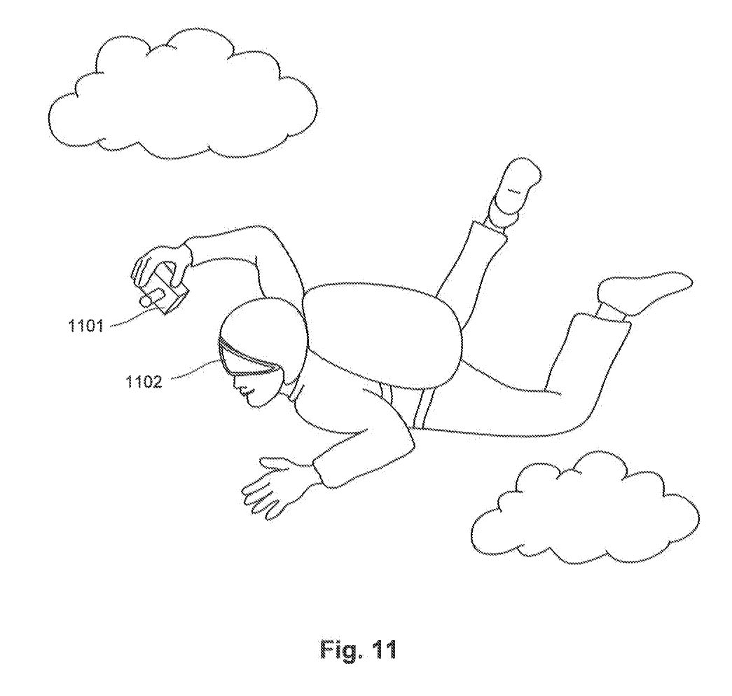

As an example, the first embodiment will be described in the context of an extreme sport, such as skydiving. As shown in FIG. 11, a skydiver can carry an action camera 1101 with him or her during a jump. The action camera can be turned on during or before a jump, and the action camera can be configured to capture an image by, for example, taking pictures or videos of a scene surrounding the skydiver. The action camera can encode data of a captured image (or a number of captured images) as a data stream of the image while the action camera is being used to capture one or more images.

In step 402, an instruction is transmitted from an image displaying device and is received by the image capturing device. The image capturing device can be physically separated or separable from the image displaying device while the instruction is being transmitted. The instruction can include an instruction for controlling image capturing on the image capturing device. Alternatively, or additionally, the instruction can include an instruction for setting one or more device parameters of the image capturing device. During or before a skydiving jump, for example, an action camera carried 1101 by a skydiver can be operated or controlled upon receiving an instruction transmitted from a pair of smart glasses 1102 worn by the skydiver.

As shown in FIG. 11, the action camera 1101 can be physically separated or separable from the smart glasses 1102. For example, the action camera 1101 can be physically separated from the smart glasses 1102 while the smart glasses 1102 are transmitting the instruction to the action camera 1101. One or more parameters of the action camera, such as a lens focal length or a shutter speed of the action camera, can be changed or adjusted in response to the instruction received by the action camera. For example, the smart glasses can include a speech recognition function allowing operation of the smart glasses by the skydiver. The skydiver can issue a voice command to the smart glasses by saying, for example, “zoom in five times,” which may be received by the smart glasses at a voice input terminal or port (e.g., including a microphone). The smart glasses may then transmit an instruction in response to the voice command of “zoom in five times” to the action camera. Alternatively, or additionally, the skydiver can issue a voice command to the image capturing device by speaking (e.g., “zoom in five times”) directly to a voice input terminal of the image capturing device when, for example, the action camera is being used in the vicinity of the smart glasses.

In step 403, one or more operations corresponding to the received instruction are executed by the image capturing device. For example, one or more operations corresponding to the received instruction are executed by the image capturing device. In the skydiving example, the action camera zooms in the lens focal length five times according to the instruction in response to the voice command of “zoom in five times.”

In step 404, an image is transmitted by the image capturing device to the image displaying device for real-time playback of the transmitted image. The playback may be performed at the same time the image capturing device is capturing one or more images. In some instances, a data stream constituting an image transmitted to the image displaying device and played back in real time can be a data stream of an image captured by the image capturing device. In the skydiving example, the action camera transmits a data stream of an image to the smart glasses for real-time display of the transmitted image. The smart glasses can display the transmitted image in real time as the image capturing device is capturing one or more images.

As seen in the first embodiment, the action camera receives an instruction from the smart glasses via communications between the action camera and the smart glasses. The action camera may be further configured to transmit a data stream or an image to the smart glasses. The action camera is physically separated or separable from the smart glasses. The smart glasses can transmit an instruction to the action camera while the action camera is capturing images. The action camera can execute operations according to the instruction while capturing images. The smart glasses may be worn by the user (e.g., a skydiver) so as to be relatively stationary with respective to the eyesight of the user. Wearing the smart glasses, the user can view in real time images captured by the action camera at the same time the user is using the action camera to perform image capturing.

Since an instruction in response to, for example, a user command, to change the capturing operations and/or settings of the action camera can be transmitted from the smart glasses to the action camera and the action camera can execute one or more operations corresponding to the instruction while capturing or being in a mode of capturing one or more images, the action camera can be instructed to change an operation or setting without having to stop capturing images. The user can continue capturing images while being able to control or adjust one or more parameters of the action camera in real time via the smart glasses. In addition, the images can be viewed benefiting from the separation of the smart glasses and the action camera without limitations imposed by the action camera, which may be in a motion while capturing images. Thus, the user can monitor or view the images captured by the action camera to see if they are desirable to the user in terms of clarity, completeness, etc. The user can also control or adjust one or more parameters of the action camera based on the captured images.

### Second Embodiment

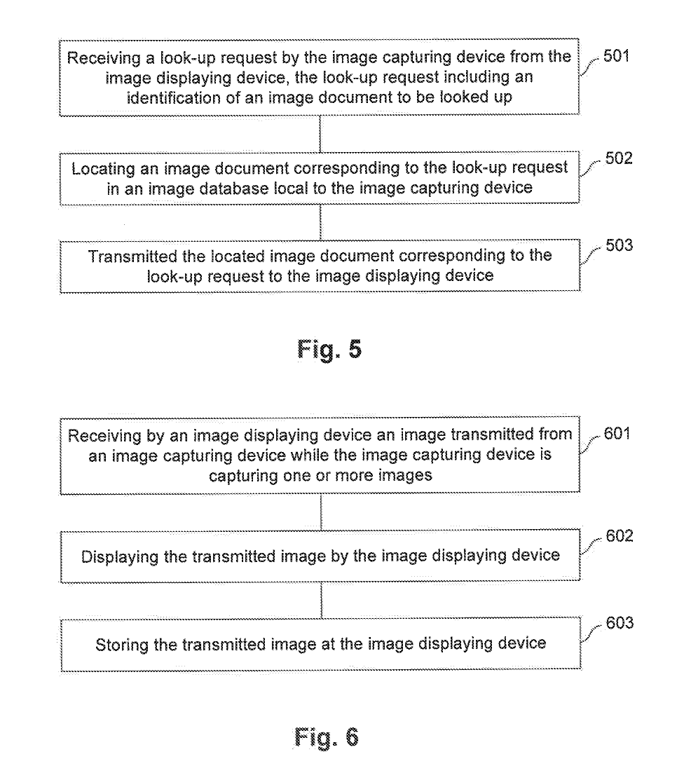

FIG. 5 illustrates a number of steps that can be included in a method of capturing an image by an image capturing device for real-time display of the captured image by an image displaying device that is physically separated or separable from the image capturing device according to a second embodiment of the disclosure. The method of the second embodiment may include, in part or in whole, the steps in the first embodiment. The steps shown in FIG. 5 can be applied to an action camera and will be described below.

In step 501, a look-up request is received by the image capturing device from the image displaying device, the look-up request including an identification of an image document to be looked up. In the skydiving example, the skydiver can issue a look-up request through the smart glasses to the action camera when the user would like to view an image (e.g., picture or video) previously captured by the action camera. For example, a look-up request can include a specific point in time of an image document to be looked up. The skydiver can issue an instruction to the smart glasses by speech commands, such as by saying, for example, “look up the image captured thirty seconds ago” to a voice input terminal of the smart glasses. In response, the smart glasses may transmit a look-up request corresponding to the command “look up the image captured thirty seconds ago” to the action camera. Alternatively, it may be convenient for the user to speak the voice command of “look up the image captured thirty seconds ago” directly to a voice input of the action camera, if the action camera is being used in the same vicinity as the smart glasses.

In step 502, an image document corresponding to the look-up request is located in an image database local to the image capturing device. The local image database may reside in an image capturing device while images are being captured by the image capturing device. The local image database can be built into the image capturing device. Alternative, or additionally, the local image database can be a memory card or any storage device capable of being inserted in or attached to the image capturing device. In the skydiving example, the action camera may locate an image document (e.g., an image document that was captured thirty seconds ago) in an image database local to the action camera according to the look-up request corresponding to the instruction or command of “look up the image captured thirty seconds ago” after the action camera receives the look-up request from the smart glasses.

In step 503, the located image document corresponding to the look-up request is transmitted from the image capturing device to the image displaying device. In the skydiving example, the action camera may transmit an image document (e.g., an image document that was captured thirty seconds ago) located according to the look-up request to the smart glasses, which may then display, for example, in real time, the image document for viewing by the skydiver.

In the second embodiment, an image document is transmitted to the smart glasses based on the look-up request sent from the smart glasses. The image document that has been looked up and transmitted from the action camera can be played back at the smart glasses while the action camera is capturing one or more images. Wearing the smart glasses, the user can request a specific image and view the image in real time as the user is also using the action camera to perform image capturing. The requested image may be provided and viewed on demand and in real time without having to stop or pause the capturing operations of the action camera. For example, the user can easily look up a previously captured image and view the image from the smart glasses even if the action camera may be being moved around by the user to capture images or may be shaking a lot due to the capturing conditions. The look-up request can be carried out while action camera and the smart glasses are physically separated or separable from each other.

The example of an extreme sport such as skydiving is only one of many fields to which the embodiments of the disclosure are applicable. Other fields to which the disclosure may be applied include outdoor activities, indoor activities, surveillance, or other sports or entertainment activities. As stated above, images captured can include, inter alia, pictures and/or video. The images can be still (static) or moving (dynamic). The embodiments described above relate to exemplary implementations of the disclosure by an image capturing device. Embodiments below will describe how the disclosure may be implemented in an image displaying device.

FIG. 6 illustrates a method of displaying an image in real time by an image displaying device that is physically separated or separable from an image capturing device that has captured the image according to some embodiments of the disclosure. The method can be implemented for use of an image displaying device. As shown in FIG. 6, the method can include a number of steps, but it need not include all of them. In some embodiments, the method can be implemented using only steps 601 and 602. In step 601, an image displaying device receives an image transmitted in real time from an image capturing device while the image capturing device is capturing one or more images. In step 602, an image is displayed or played back by the image displaying device, for example. The image capturing device can be physically separated or separable from the image displaying device. For example, the image displaying device can be physically separated or separable from the image capturing device while the image displaying device may be receiving an image transmitted from the image capturing device and/or displaying the transmitted image. As described above, an image can be constituted by a data stream and can be transmitted as a data stream and displayed from a data stream.

In some embodiments, the method of displaying an image in real time by an image displaying device that is physically separated or separable from an image capturing device that has captured the image can include an additional step 603 (FIG. 6) of locally storing the transmitted image at the image displaying device. The image displaying device can include a storage device for storing images. In the skydiving example, locally storing images at the smart glasses may be beneficial as images can be directly looked up at the smart glasses in the future without having to transmit the same images from the action camera again for any future look-up. Since a transmitted image can be stored at the smart glasses, this can save the user the need of looking up and retrieving the same images at the action camera every time the user wants to view them, thus reducing the number of operations needed to transmit image documents to the smart glasses and saving power of the action camera and/or the smart glasses.

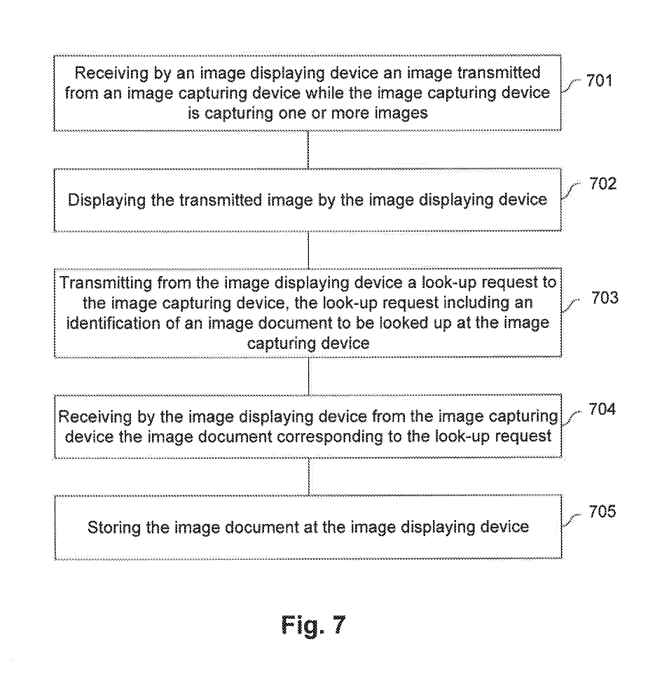

In some embodiments, as shown in FIG. 7, a method displaying an image in real time by an image displaying device that is physically separated or separable from an image capturing device that has captured the image can include steps 701 and 702 that are similar to steps 601 and 602 in FIG. 6 and include additional steps of: transmitting from the image displaying device a look-up request to the image capturing device, the look-up request including an identification of an image document to be looked up at the image capturing device (step 703); receiving by the image displaying device from the image capturing device the image document corresponding to a look-up request (step 704); and locally storing the image document at the image displaying device (step 705). In the skydiving example, a look-up request may be transmitted from the smart glasses to the action camera, and an image document corresponding to the look-up request may be transmitted to and locally stored at the smart glasses. Because the separation of the action camera from the smart glasses, the skydiver can keep capturing images while at the same time looking up an image previously captured in the action camera without having to stop image capturing. The images captured by the action camera can be transmitted to and stored at the smart glasses for future look-up and viewing without having to transmit them from the action camera every time a user wants to view them. Thus, it may be convenient for the user to look up and view the captured images without limitations imposed by the action camera.

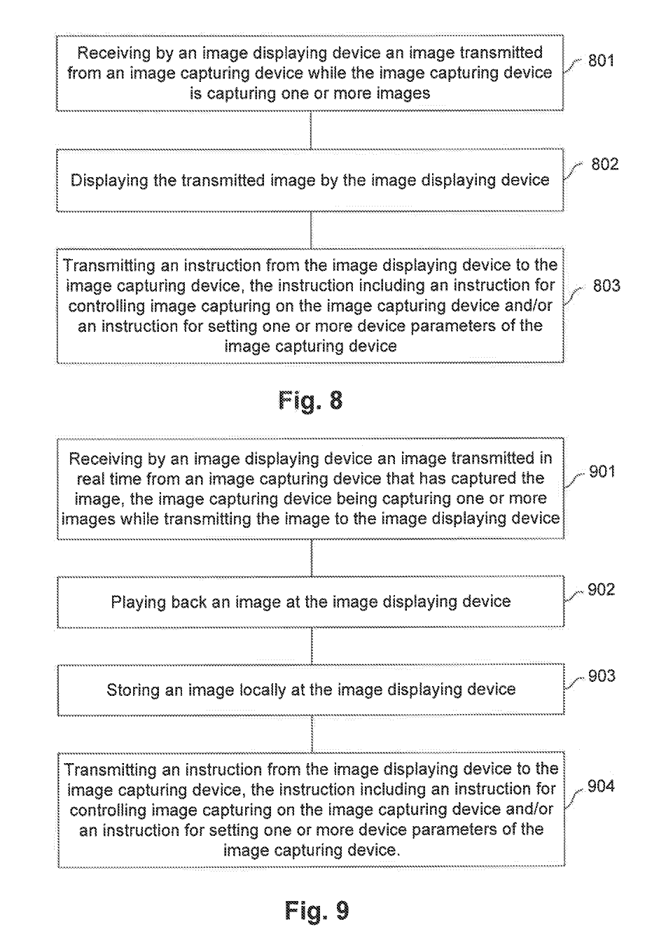

In some embodiments, as shown in FIG. 8, a method of displaying an image in real time by an image displaying device that is physically separated or separable from an image capturing device that has captured the image can include steps 801 and 802 that are similar to steps 601 and 602 in FIG. 6 and include an additional step of: transmitting an instruction from the image displaying device to the image capturing device, the instruction including an instruction for controlling image capturing on the image capturing device and/or an instruction for setting one or more device parameters of the image capturing device (step 803). The image capturing device can be configured to execute one or more operations corresponding to the instruction.

In the skydiving example, the smart glasses can display or play back in real time a received image from the action camera while being able to transmit an instruction to control or change the image capturing operation and/or one or more parameters of the action camera. The smart glasses can transmit an instruction to the action camera while the action camera is capturing images. The action camera can execute operations according to the instruction while capturing images. As will be discussed in more detail below, the skydiver can issue the instruction through the smart glasses to the action camera without interrupting the ongoing activity of image capturing.

Embodiments below will describe in detail exemplary implementations of a method of displaying an image in real time by an image displaying device that is physically separated or separable from an image capturing device that has captured the image according to the disclosure.

### Third Embodiment

FIG. 9 illustrates a method of displaying an image in real time by an image displaying device that is physically separately from an image capturing device that has captured the image according to a third embodiment of the disclosure. The method is applicable to an image displaying device such as a pair of smart glasses. The method will be described below in terms of a number of steps as shown in FIG. 9.

In step 901, an image displaying device receives an image transmitted in real time from an image capturing device that has captured the image. The image capturing device may be capturing images while transmitting the image to the image displaying device. In the skydiving example, the smart glasses can be configured to receive an image having been captured by the action camera while the action camera is capturing images.

In step 902, an image is played back at the image displaying device. In this step, an image for playback can include the image received in step 901. Alternatively, an image for playback may be different from the received image in step 901. In the skydiving example, the smart glasses may play back in real time an image while receiving an image transmitted from the action camera. Alternatively, the transmitted image can be played back by the smart glasses while the action camera is capturing images.

In step 903, an image is locally stored at the image displaying device. An image locally stored can include the transmitted image received in step 901 and/or the image played back in step 902. In the skydiving example, the smart glasses may include a local storage such as a memory. An image, such the image received from the action camera, can be stored in the local storage of the smart glasses.

In step 904, an instruction is transmitted from the image displaying device to the image capturing device, the instruction including an instruction for controlling image capturing on the image capturing device and/or an instruction for setting one or more device parameters of the image capturing device. The image capturing device can be configured to execute one or more operations corresponding to the instruction. In the skydiving example, the smart glasses can be configured to transmit an instruction, such as an instruction to control the action camera and/or an instruction to set a device parameter of action camera, to the action camera at the same time the smart glasses are playing back and/or storing an image. The playback (or storing) and transmission of the image can also occur at the same time image capturing is being performed at the action camera. The skydiver can transmit an instruction to the action camera through the smart glasses to change parameters such as the lens focal length or shutter speed of the action camera. The skydiver can issue a voice command to the smart glasses by saying, for example, “zoom in five times,” which is picked up by the smart glasses at a voice input terminal. The smart glasses then transmit an instruction in response to the voice command of “zoom in five times” to the action camera.

In the third embodiment, an image captured by an image capturing device is received and played back using an image displaying device. The user can also send an instruction through the image displaying device to the image capturing device to change an operation or device parameter of the image capturing device. Since the image displaying device is physically separated from the image capturing device, a user can view in real time images captured by the image capturing device at the same time the image capturing device is being used to perform image capturing. The use can also change the operation or device settings of the image capturing device at the same time the image capturing device is being used to perform image capturing. Thus, the user can view the images and operate the image capturing device without limitations imposed by the image capturing device. For example, the user can keep capturing images using the image capturing device, view the captured images, and change the operation and/or device settings of the image capturing device without the need to interrupt or stop image capturing. Images captured by the image capturing device can be monitored at any time for clarity or completeness even if the image capturing device is being moved around a lot while performing image capturing. The user can also control or adjust parameters of the image capturing device in real time based on the captured images.

### Fourth Embodiment

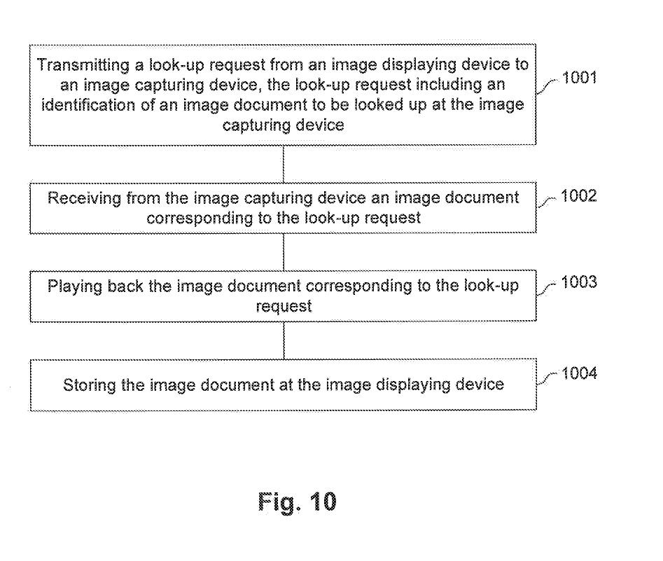

FIG. 10 illustrates a method of displaying an image in real time by an image displaying device that is physically separated or separable from an image capturing device that has captured the image according to a fourth embodiment of the disclosure. The method can be applied to an image displaying device such as a pair of smart glasses and will be described below in terms of a number of steps as shown in FIG. 10. The method can include one or more steps of the third embodiment.

In step 1001, a look-up request is transmitted from an image displaying device to an image capturing device, the look-up request including an identification of an image document to be looked up at the image capturing device. As in the skydiving example, a skydiver equipped with an action camera and a pair of smart glasses can transmit a look-up request to the action camera through the smart glasses. A look-up request can include a specific point in time of an image document to be looked up. The skydiver can issue an instruction to the smart glasses by speech commands, such as by saying, for example, “look up the image captured thirty seconds ago” to a voice input terminal or port of the smart glasses. In response, the smart glasses transmit a look-up request corresponding to the command “look up the image captured thirty seconds ago” to the action camera.

In step 1002, an image document corresponding to the look-up request is received by the image displaying device from the image capturing device. In the skydiving example, the smart glasses receive an image document corresponding to the look-up request associated with the voice command “look up the image captured thirty seconds ago” from the action camera.

In step 1003, the received image document corresponding to the look-up request is played back by the image displaying device. In the skydiving example, smart glasses play back the received image document corresponding to the look-up request associated with the voice command “look up the image captured thirty seconds ago.” The smart glasses may play back the image document by displaying the image document in a display of the smart glasses. Alternatively, or additionally, the image document can be played back or displayed as nested in or floating on another image on the display of the smart glasses.

In step 1004, the image document is stored locally at the image displaying device. In the skydiving example, an image document, such as an image having been received from the action camera, can be stored in the smart glasses.

In the fourth embodiment, a look-up request is transmitted to an image capturing device, and an image document corresponding to the look-up request and transmitted from the image capturing device is played back and stored. In the skydiving example, the smart glasses are worn by the user (e.g., skydiver) and remain relatively stationary with respect to the eyesight of the user. The user can view in real time images previously captured by the action camera by issuing an instruction through the smart glasses to the action camera at the same time the user is using the action camera to perform image capturing. Thus, it may be convenient for the user to look up and view images captured and stored in the smart glasses without having to interrupt or stop the image capturing operation the user is doing using the action camera.

The above skydiving example is only one of many fields to which the embodiments of the disclosure are applicable. Other fields to which the disclosure may be applied include outdoor activities, indoor activities, surveillance, or other sports or entertainment activities.

It is understood that, according to the disclosure, an image capturing device can be physically separated from an image displaying device while one or more steps discussed herein is being performed. In that sense, the image capturing device and the image displaying device may be configured to be combined but are separable. For example, the image capturing device can be separated from being attached to the image displaying device while a captured image by the image capturing device is being displayed by the image displaying device. As used herein, “separable” can refer to the configuration or capability of being physically separated while one or more steps of a method according to the disclosure are being performed.

It is understood that, in some embodiments of the disclosure, an image displayed in real time by an image displaying device can be an image already stored in the image displaying device while another image is being transmitted from an image capturing device to the image displaying device. In some embodiments, an image stored in an image displaying device can be an image already, or completely, transmitted from an image capturing device to the image displaying device while the another image is being transmitted from the image capturing device to the image displaying device.

In some embodiments, there may be provided two or more image capturing devices to work with a single image displaying device. For example, an image can be transmitted from a first image capturing device to an image displaying device, which may transmit an instruction to a second image capturing device. This has a benefit that images can be captured and monitored simultaneously from different angles or positions. In some embodiments, there may be provided two or more image displaying devices to work with a single image capturing device. For example, an image captured by an image capturing device can be sent to a first image displaying device and a second image displaying device. The first image displaying device and/or the second image displaying device can individually or in combination issue an instruction to the image capturing device and perform other operations such as storing the captured image as discussed above. In some embodiments, there may be provided a plurality of image capturing devices to work with a plurality of image displaying devices. For example, a first image capturing device may be capturing images and transmitting a captured image to a second image displaying device. At the same time, the second image displaying device can transmit an instruction to a third image capturing device, which can transmit an image to a fourth image displaying device for real-time display of the image.

In some embodiments, an image capturing device and an image displaying device can be operated by different users. In the skydiving example, there may be a first user who is holding the action camera to capture images, and a second user who is wearing the smart glasses to view the captured images and issue instruction through the smart glasses to the action camera. In some embodiments, a single device can be operated by two or more users. In the skydiving example, two or more users can wear smart glasses that can work with one or more action cameras.

Furthermore, alternatively and consistent with aspects of the present disclosure, as mentioned above, the image capturing device may first generate a view of a scene without capturing an image, generate data reflecting the view, and send the data to the image display device for real-time display of the view. The user may, based on the displayed view of the scene, adjust the position and/or orientation of the image capturing device so that a desired image may be captured, e.g., stored as an image file.

It should be noted that the steps described above and in the figures should not be limited to a particular order presented, and a method according to the disclosure can include steps from different embodiments. In addition, one or more steps disclosed herein may be repeated, performed simultaneously, or performed in an order not explicitly described but nevertheless consistent with the principle of the disclosure.

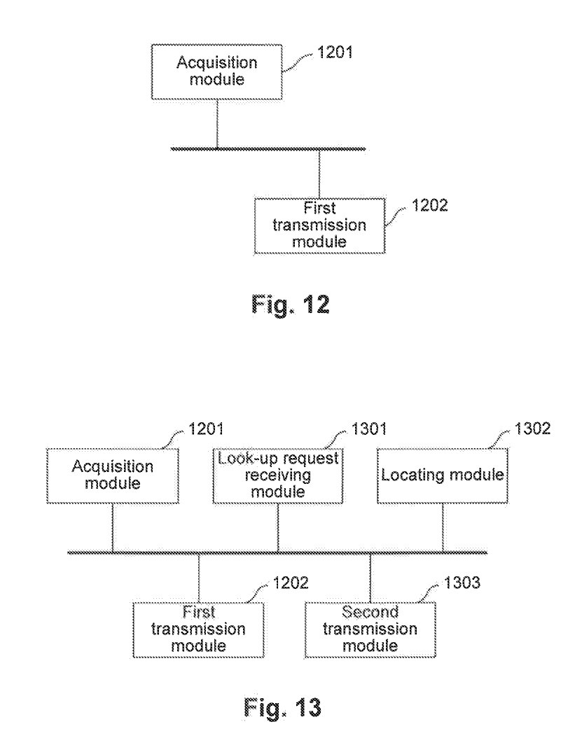

FIG. 12 illustrates a block diagram of an apparatus for capturing an image for real-time display by an image displaying device that is physically separated or separable from the image capturing device according to some embodiments of the disclosure. The apparatus can include an acquisition module 1201 configured to capture an image of a scene and acquire an image, or, a data stream of an image, and a first transmission module 1202 configured to transmit in real time a data stream of an image to an image displaying device at the same time image capturing is being performed by the acquisition module 1201. The image displaying device can be configured to receive and play back in real time an image or a data stream of an image. The apparatus can be physically separated or separable from the image displaying device. For example, the image displaying device can be displaying or playing back an image transmitted form the apparatus while the apparatus is capturing one or more images or in a mode capable of capturing images.

As shown in FIG. 13, the apparatus described in conjunction with FIG. 12 can additionally include a look-up request receiving module 1301 configured to receive a look-up request transmitted by the image displaying device, a locating module 1302 configured to locate in an image database local to the apparatus an image document corresponding to the look-up request, and a second transmission module 1303 configured to transmit an image document corresponding to the look-up request and located by the locating module 1302 to the image displaying device. The look-up request can include an identification of an image document to be looked up at the apparatus.

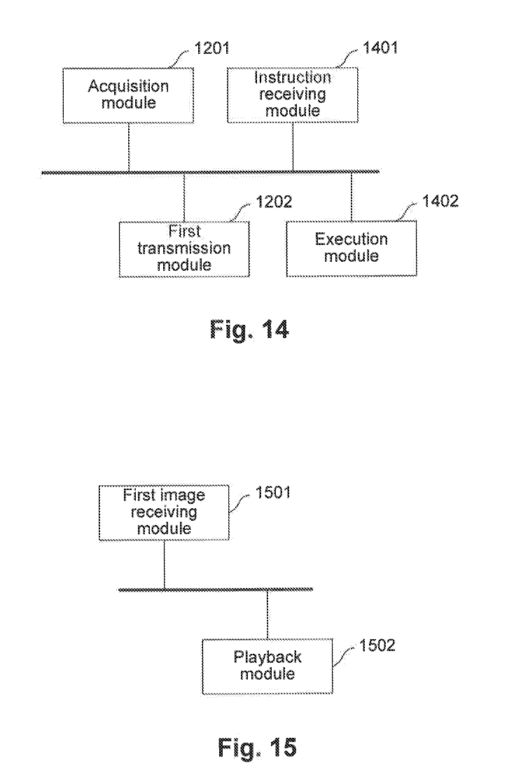

As shown in FIG. 14, the apparatus described in conjunction with FIG. 12 can additionally include an instruction receiving module 1401 configured to receive an instruction transmitted from the image displaying device and an execution module 1402 configured to execute one or more operations corresponding to the instruction. The instruction can include an instruction for controlling image capturing on the apparatus and/or an instruction for setting one or more device parameters of the apparatus.

FIG. 15 illustrates a block diagram of an apparatus for displaying an image in real time, the image having been captured by an image capturing device that is physically separated or separable from the apparatus, according to some embodiments of the disclosure. The apparatus can include a first image receiving module 1501 configured to receive an image or a data stream of an image transmitted in real time from an image capturing device at the same time image capturing is being performed at the image capturing device and a playback module 1502 configured to play back an image or a data stream of an image. The apparatus can be physically separated or separable from the image capturing device. For example, the image capturing device can be capturing one or more images at the same time the apparatus is receiving an image from the image capturing device and/or displaying the image received from the image capturing device.

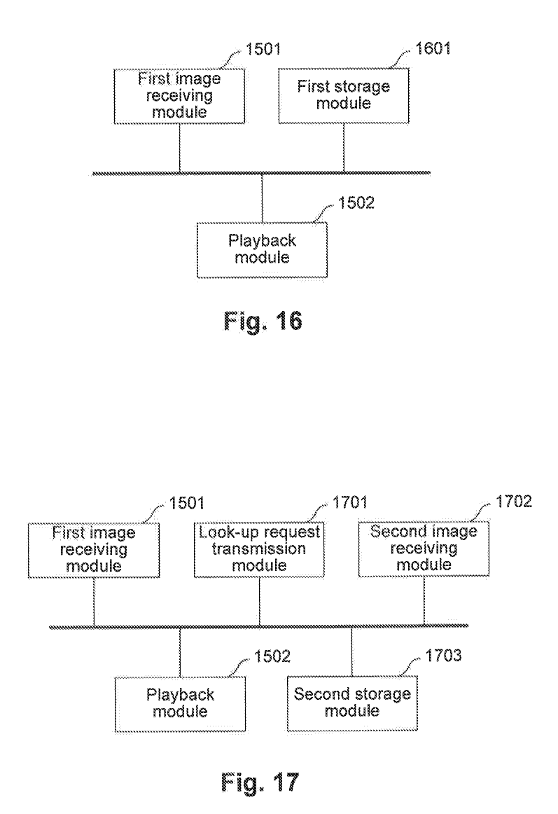

As shown in FIG. 16, the apparatus described in conjunction with FIG. 15 can additionally include a first storage module 1601 configured to store an image or a data stream of an image locally at the apparatus.

As shown in FIG. 17, the apparatus described in conjunction with FIG. 15 can additionally include a look-up request transmission module 1701 configured to transmit a look-up request to the image capturing device, a second image receiving module 1702 configured to receive an image document corresponding to the look-up request and transmitted from the image capturing device, and a second storage module 1703 configured to store the image document locally at the apparatus. The look-up request can include an identification of an image document to be looked up at the image capturing device.

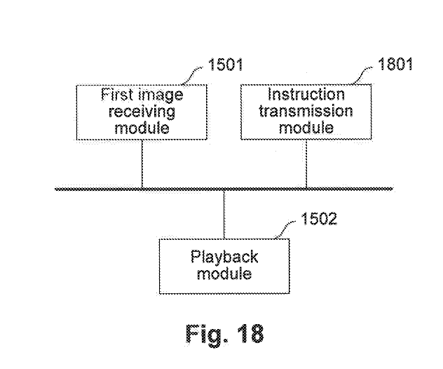

As shown in FIG. 18, the apparatus described in conjunction with FIG. 15 can additionally include an instruction transmission module 1801 configured to transmit an instruction to the image capturing device. The instruction can include an instruction for controlling image capturing on the image capturing device and/or an instruction for setting one or more device parameters of the image capturing device. The image capturing device can be configured to execute one or more operations corresponding to the instruction.

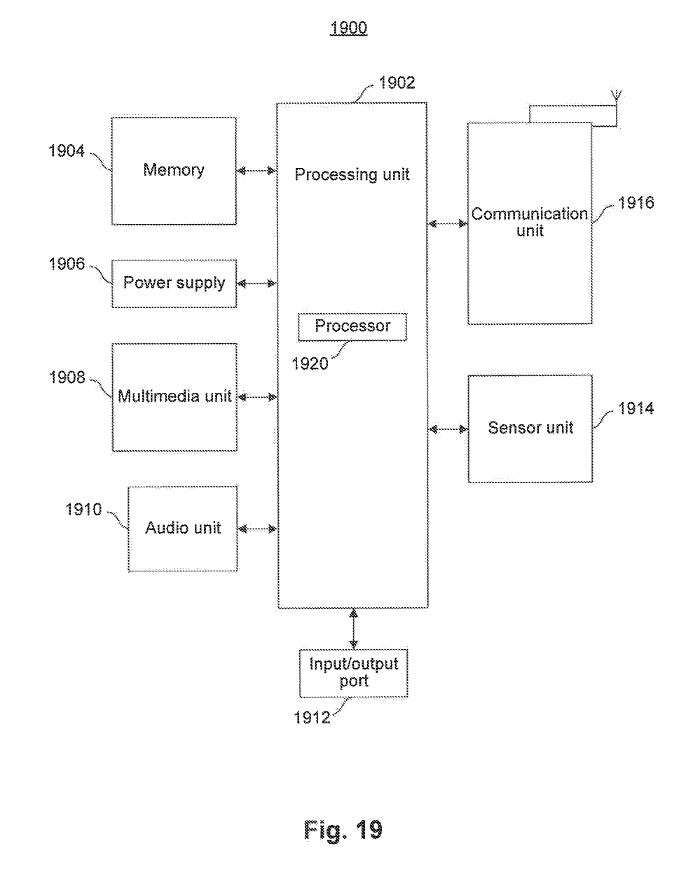

FIG. 19 illustrates a block diagram representing an apparatus 1900 for use in capturing an image for real-time display by an image displaying device that is physically separated or separable from the apparatus according to some embodiments of the disclosure. Alternatively, the block diagram of FIG. 19 can represent another apparatus for displaying in real time an image captured by an image capturing device that is physically separated or separable from the apparatus according to some embodiments of the disclosure. Apparatus 1900 can include a mobile phone, a calculator, a digital radio terminal, an information transmission device, a game console, a tablet computer, a medical device, an exercise apparatus, a personal digital assistant, etc.

As shown in FIG. 19, apparatus 1900 includes one or more of the following: a processing unit 1902, a memory 1904, a power supply 1906, a multimedia unit 1908, an audio unit 1910, an input/output (I/O) port 1912, a sensor unit 1914, and a communication unit 1916.

Processing unit 1902 can be configured to control an overall operation of apparatus 1900. For example, processing unit 1902 can control an operation such as displaying, calling, data communications, camera operations, storage operations, or other relevant operations to apparatus 1900. Processing unit 1902 can include one or more processors 1920 for executing instructions to one or more steps of a method disclosed herein. Processing unit 1902 can include one or more modules for communicating and processing in conjunction with one or more units or components in apparatus 1900. For example, processing unit 1902 can include a multimedia module for communicating and processing in conjunction with multimedia unit 1908.

Memory 1904 can be configured to store a number of types of data to support operations of apparatus 1900. The data stored in memory 1904 can include any instructions of an application or method capable of being operated with respect to apparatus 1900. In addition, the data stored in memory 1904 can include personal data, contact data, pictures, videos, and any other type of data or information. Memory 1904 can be realized using any type of a volatile or non-volatile storage or a combination thereof and can include, but may not be limited to, a random-access memory (RAM), a static random access memory (SRAM), an electrically erasable programmable read-only memory (EEPROM), an erasable programmable read-only memory (EPROM), a programmable read-only memory (PROM), a read-only memory (ROM), a magnetic storage, a flash memory, a magnetic disk, and an optical disk, etc.

Power supply 1906 can be configured to provide electric power to various units or components of apparatus 1900. Power supply 1906 can include a power management system and one or more power sources. In addition, power supply 1906 can include one or more devices for generating, handling, and/or distributing electric power for apparatus 1900.

Multimedia unit 1908 can be configured to provide, between apparatus 1900 and a user, a display device at an output port of apparatus 1900. In some embodiments, a display device of multimedia unit 1908 can include a liquid crystal display (LCD) and/or a touch panel (TP) display. For example, the display device can be implemented as a touch panel display, which can be configured to receive and process tactile signals inputted from a user. A touch panel display can include one or more tactile sensors for sensing touching and sliding contacts and gestures on the display. The sensors can be configured to detect duration and pressure of touching or sliding contacts as well as sensing an end point of the touching and sliding contacts. In some embodiments, multimedia unit 1908 can include a front-facing camera and/or a back-facing camera. When apparatus 1900 is being operated under a photographing or video recording mode, the front camera and/or the back camera can receive external multimedia data. As used herein, each of a front camera and a back camera can include a prime lens optical system and/or a system having a zoom lens. The camera may be implemented by a digital camera, such as a CCD or CMOS camera, and may be an Internet protocol camera, or IP camera. The camera may be configured to sense visible or invisible light, such as infrared (IR) or ultraviolet (UV) light.

Audio unit 1910 can be configured to input and/or output audio signals. For example, audio unit 1910 can include a microphone (MIC), which can be configured to receive external audio signals when apparatus 1900 is being operated under a calling, recording, or voice recognition mode. Audio signals received by audio unit 1910 can be stored in memory 1904 and/or transmitted through communication unit 1916. In some embodiments, audio unit 1910 can also include a speaker for outputting audio signals.

I/O port 1912 can be configured to provide a port or connection point between processing unit 1902 and a peripheral interface module, which can include a keyboard, a click wheel, a button or key, etc. A button or key as used herein can include, but is not limited to, soft buttons (including touch-screen buttons), as well as physical buttons, keys, or switches.

Sensor unit 1914 can include one or more sensors and be configured to detect various states of apparatus 1900. For example, sensor unit 1914 can be configured to detect an on/off state of apparatus 1900 and relative positions of units or components such as a display device and a keypad of apparatus 1900. Sensor unit 1914 can also be configured to detect a change in position of apparatus 1900 or a unit or component of apparatus 1900. In addition, sensor unit 1914 can be configured to detect whether a user is in physical contact with apparatus 1900. Further, sensor unit 1914 can be configured to detect an orientation, a state of acceleration or deceleration, a temperature or a change therein of apparatus 1900. Furthermore, sensor unit 1914 can include a proximity sensor for sensing object proximity without any physical contact, and/or an optical sensor, such as CMOS or CCD image sensor, for an imaging application. In some embodiments, sensor unit 1914 can include an accelerometer, a gyroscope, a magnetic sensor, a pressure sensor, and/or a thermal sensor.

Communication unit 1916 can be configured to provide wired and wireless communications between apparatus 1900 and other devices. Communication unit 1916 can be configured to be connected to a standards-based wireless network such as WiFi, 2G, 3G, 4G, 5G, or a combination thereof. In some embodiments, communication unit 1916 can be configured to receive a radio signal or a signal related thereof from an external radio system via a broadcast channel. In some embodiments, communication unit 1916 can include a near-field communication (NFC) module to facilitate short range communications. For example, a NFC module can be implemented using a technology including or provided by radio-frequency identification (RFID), Infrared Data Association (IrDA), ultra wideband (UWB), Bluetooth (BT), and other communication protocols.

In some embodiments, apparatus 1900 can be implemented using one or more of the following devices that can be configured to process or execute a method disclosed herein: an application-specific integrated circuit (ASIC), a digital signal processor (DSP), a digital signal processing device (DSPD), a programmable logic device (PLD), a field-programmable gate array (FPGA), a controller, a microcontroller, microprocessor or other electronic devices.

In some embodiments, there is provided a non-transitory computer-readable media including instructions, such as memory 1904 including instructions, that can be executed by processor 1920 of apparatus 1900 to accomplish a method disclosed herein. For example, the non-transitory computer-readable media can include a ROM, a RAM, a CD-ROM, a magnetic tape, a soft disk, an optical storage, etc.

In some embodiments, there is provided a non-transitory computer-readable media including instructions, which, when executed by a processor of a mobile device, cause the mobile device to execute one or more steps of a method described above according to some embodiments of the disclosure. In some embodiments, there is provided an apparatus for performing one or more steps of method described above according to some embodiments of the disclosure. The apparatus can be used for an image capturing device or an image displaying device and include a processor and a memory for storing instructions executable by the processor, which can be configured to perform one or more steps of method described above according to some embodiments of the disclosure.

As is understood by a person of ordinary skill in the art, embodiments of the disclosure can be implemented in the form of a method, a system, or a computer product. The disclosure can be implemented as an embodiment including hardware, software, firmware, or any combination thereof. Moreover, an embodiment of the disclosure can be implemented as a product of a computer program capable of being executed from one or more computer usable media (including, but not limited to, a magnetic disk storage or an optical storage) including programmable computer codes.

The disclosure is illustrated in reference to methods, apparatus (systems), flow charts and/or block diagrams of products of computer programs according to various embodiments of the disclosure. It should be understood that each step and/or block in the flow charts and/or block diagrams and any combination of steps and/or blocks in the flow charts and/or block diagrams can be implemented by using computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method of capturing an image for real-time display, comprising:
capturing an image of a scene by an image capturing device; and
transmitting the image from the image capturing device to an image displaying device for real-time display,
wherein the image displaying device is physically separated or separable from the image capturing device when displaying the image.

2. The method according to claim 1, further comprising:
receiving, by the image capturing device, a look-up request transmitted from the image displaying device, the look-up request including an identification of an image document to be looked up at the image capturing device;
locating in an image database local to the image capturing device an image document corresponding to the look-up request; and
transmitting from the image capturing device the image document corresponding to the look-up request to the image displaying device.

3. The method according to claim 1, further comprising:
receiving, by the image capturing device, a first instruction transmitted from the image displaying device, the first instruction including a second instruction for controlling image capturing on the image capturing device or a third instruction for setting one or more device parameters of the image capturing device or both the second and third instructions;
executing by the image capturing device one or more operations corresponding to the first instruction.

4. A method of displaying an image in real time, comprising:
receiving by an image displaying device an image transmitted in real time from an image capturing device at the same time the image capturing device is capturing one or more images; and
playing back in real time the image,
wherein the image displaying device is physically separated or separable from the image capturing device when playing back the image.

5. The method according to claim 4, further comprising:
storing locally the image at the image displaying device.

6. The method according to claim 4, further comprising:
transmitting from the image displaying device a look-up request to the image capturing device, the look-up request including an identification of an image document to be looked up at the image capturing device;
receiving an image document corresponding to the look-up request; and
storing locally the image document at the image displaying device.

7. The method according to claim 4, further comprising:
transmitting from the image displaying device a first instruction to the image capturing device, the first instruction including a second instruction for controlling image capturing on the image capturing device or a third instruction for setting one or more device parameters of the image capturing device or both the second and third instructions, the image capturing device being configured to execute one or more operations corresponding to the first instruction.

8. An apparatus for capturing an image for real-time display of the image, comprising:
an acquisition module for capturing an image of a scene; and
a first transmission module for transmitting the image to an image displaying device for real-time display,
wherein the image displaying device is physically separated or separable from the apparatus when displaying the image.

9. The apparatus according to claim 8, further comprising:
a look-up receiving module for receiving a look-up request transmitted from the image displaying device, the look-up request including an identification of an image document to be looked up at the apparatus;
a locating module for locating in an image database local to the apparatus an image document corresponding to the look-up request; and
a second transmission module for transmitting the image document corresponding to the look-up request to the image displaying device.

10. The apparatus according to claim 8, further comprising:
an instruction receiving module for receiving a first instruction transmitted from the image displaying device, the first instruction including a second instruction for controlling image capturing on the apparatus or a third instruction for setting one or more device parameters of the apparatus or both the second and third instructions; and
an execution module for executing one or more operations corresponding to the first instruction.

11. An apparatus for displaying an image in real time, comprising:
a first image receiving module for receiving an image transmitted in real time from an image capturing device at the same time the image capturing device is capturing one or more images; and
a playback module for playing back in real time the image,
wherein the apparatus is physically separated or separable from the image capturing device when playing back the image.

12. The apparatus according to claim 11, further comprising:
a first storage module for storing the image.

13. The apparatus according to claim 11, further comprising:
a look-up request transmission module for transmitting a look-up request to the image capturing device, the look-up request including an identification of an image document to be looked up at the image capturing device;
a second image receiving module for receiving an image document corresponding to the look-up request; and
a first storage module for storing the image document.

14. The apparatus according to claim 11, further comprising:
an instruction transmission module for transmitting a first instruction to the image capturing device, the first instruction including a second instruction for controlling image capturing on the image capturing device or a third instruction for setting one or more device parameters of the image capturing device or both the second and third instructions, the image capturing device being configured to execute one or more operations corresponding to the first instruction.

15. An apparatus for capturing an image for real-time display, comprising:
a processor; and
a memory for storing instructions executable by the processor,
wherein the processor is configured to:
capturing an image of a scene; and
transmit the image to an image displaying device for real-time display,
wherein the image displaying device is physically separated or separable from the apparatus when displaying the image.

16. The apparatus according to claim 15, wherein the processor is further configured to:
receive a look-up request transmitted from the image displaying device, the look-up request including an identification of an image document to be looked up at the apparatus;
locate in an image database local to the apparatus an image document corresponding to the look-up request; and
transmit the image document corresponding to the look-up request to the image displaying device.

17. The apparatus according to claim 15, wherein the processor is further configured to:
receive a first instruction transmitted from the image displaying device, the first instruction including a second instruction for controlling image capturing on the apparatus or a third instruction for setting one or more device parameters of the apparatus or both the second and third instructions; and
execute one or more operations corresponding to the first instruction.

18. An apparatus for displaying an image in real time, comprising:
a processor; and
a memory for storing instructions executable by the processor,
wherein the processor is configured to:
receive an image transmitted in real time from an image capturing device at the same time the image capturing device is capturing one or more images; and
play back in real time the image,
wherein the apparatus is physically separated or separable from the image capturing device when playing back the image.

19. The apparatus according to claim 18, wherein the processor is further configured to store the image at the apparatus.

20. The apparatus according to claim 18, wherein the processor is further configured to:
transmit a look-up request to the image capturing device, the look-up request including an identification of an image document to be looked up at the image capturing device;
receive an image document corresponding to the look-up request; and
store locally the image document at the apparatus.

21. The apparatus according to claim 18, wherein the processor is further configured to transmit a first instruction to the image capturing device, the first instruction including a second instruction for controlling image capturing on the image capturing device or a third instruction for setting one or more device parameters of the image capturing device or both the second and third instructions, the image capturing device being configured to execute one or more operations corresponding to the first instruction.

22. A method of capturing an image, comprising:
generating a view of a scene by an image capturing device;
generating data reflecting the view by the image capturing device;
transmitting the data reflecting the view from the image capturing device to an image displaying device for real-time display of the view, wherein the image displaying device is physically separated or separable from the image capturing device when displaying the view; and
capturing an image by the image capturing device based on feedback based on the displayed view.
